(19) United States
(12) Patent Application Publication
(10) Pub. No.: US 2017/0109027 A1
(43) Pub. Date: Apr. 20, 2017

(54) GEO-FENCE MANAGEMENT SYSTEM HAVING USER INTERFACE

(71) Applicant: Electro-Motive Diesel, Inc., LaGrange, IL (US)

(72) Inventors: Alexander Shubs, JR., Chicago, IL (US); David Roenspies, Elburn, IL (US)

(73) Assignee: Electro-Motive Diesel, Inc., LaGrange, IL (US)

(21) Appl. No.: 14/887,278

(22) Filed: Oct. 19, 2015

(51) Int. Cl. G06F 3/0484; G06F 3/0482; H04W 4/02

(52) U.S. Cl. CPC G06F 3/04847; H04W 4/021; G06F 3/04842; G06F 3/04845; G06F 3/0482

(57) ABSTRACT

A geo-fence management system for a machine is disclosed. The geo-fence management system may include a user interface having a display and an input device. The user interface may be configured to receive via the input device a first input indicative of geographic information, a second input indicative of an operating parameter of the machine associated with the geographic information, and a third input indicative of one or more of a task and a request to monitor data associated with the operating parameter of the machine. The geo-fence management system may also include a controller in communication with the user interface and configured to generate a command signal based on one or more of the first, second, and third inputs.

### TECHNICAL FIELD

The present disclosure relates to a management system, and more particularly, to a geo-fence management system having a user interface.

### BACKGROUND

Machines, such as passenger vehicles, trains, airplanes, marine vessels, construction equipment, etc., include many components that are susceptible to wear and failure over time. Monitoring systems have been implemented that alert operators and machine controllers of machine operating conditions to allow for improved responses to component failures. These monitoring systems have also been used in conjunction with automatic machine control strategies to improve operational efficiencies and reduce operator responsibilities. Some monitoring systems receive inputs from geographic positioning devices and apply control strategies based on the geographic positions of an associated machine. This type of geographic control strategy is known as geo-fencing.

A geo-fence is a geographic boundary or region that is recognized by monitoring systems and/or control systems when an associated machine crosses the boundary or enters the region. Geo-fences are sometimes used in conjunction with control systems to automatically enable or disable certain control features at certain geographic locations. Some known control systems equipped with geo-fencing features allow operators to establish geo-fence locations and dimensions for implementing certain operational constraints at those locations. However, some machines have numerous operational aspects that are subject to automatic as well as discretionary control. Efficient control of these machines can be difficult for operators to achieve when numerous existing geo-fences require periodic discretionary changes and/or when the establishment of additional geo-fences is desired during an ongoing operation.

A system for managing geo-fence operations of a machine is disclosed in U.S. Patent Application Publication No. 2010/0042940 A1 (the '940 publication) of Monday et al., that published on Feb. 18, 2010. In particular, the '940 publication describes a system for adjusting the size, shape, and/or location of a geo-fence via a user interface. The system includes a computer system that receives and displays information via the user interface. The user interface includes an input device and a display. The controller may show a geo-fence to the operator via the display, and the user may change the shape, size, or location of the geo-fence via the input device. The user may also select how close to the geo-fence the machine may travel before a notification is sent to the operator.

While the system of the '940 publication may allow the operator to manipulate certain aspects of geo-fences, other features and aspects of geo-fence control may yet be realized.

The disclosed geo-fence management system is directed to overcoming one or more of the problems set forth above and/or other problems of the prior art.

### SUMMARY OF THE INVENTION

In one aspect, the present disclosure is directed to a geo-fence management system for a machine. The geo-fence management system may include a user interface having a display device and an input device. The user interface may be configured to receive via the input device a first input indicative of geographic information, a second input indicative of an operating parameter of the machine associated with the geographic information, and a third input indicative of one or more of a task and a request to monitor data associated with the operating parameter of the machine. The geo-fence management system may also include a controller in communication with the user interface and configured to generate a command signal based on one or more of the first, second, and third inputs.

In another aspect, the present disclosure is directed to a method of operating a geo-fence management system having a user interface. The method may include receiving via the user interface a first input indicative of geographic information, a second input indicative of an operating parameter of a machine associated with the geographic information, and a third input indicative of one or more of a task and a request to monitor data associated with the operating parameter of the machine. The method may further include generating a command signal to control the machine based on one or more of the first, second, and third inputs.

In yet another aspect, the present disclosure is directed to a geo-fence management system for a machine. The geo-fence management system may include a user interface having a display device and an input device. The user interface may be configured to receive via the input device a first input indicative of geographic information, a second input indicative of an operating parameter of the machine associated with the geographic information, and a third input indicative of one or more of a task and a request to monitor data associated with the operating parameter of the machine. The geo-fence management system may further include a controller in communication with the user interface. The controller may be configured to generate the command signal in conjunction with a geo-fence at least partially defined by the geographic information and the operating parameter. The controller may be further configured to monitor the operating parameter indicated by the second input and generate an alert via the user interface in conjunction with a geo-fence at least partially defined by the geographic information and the operating parameter.

### BRIEF DESCRIPTION OF THE DRAWINGS

FIG. 1 is a schematic illustration of an exemplary disclosed machine network;

FIG. 2 is a schematic illustration of an exemplary disclosed machine asset and geo-fence management system that may be used in conjunction with the machine network of FIG. 1;

FIG. 3 is a diagrammatic illustration of an off-board control system that may be used in conjunction with the geo-fence management system of FIG. 2; and

FIGS. 4-7 are pictorial illustrations of exemplary disclosed graphical user interfaces (GUI) that may be used in conjunction with the geo-fence management system of FIG. 2.

### DETAILED DESCRIPTION

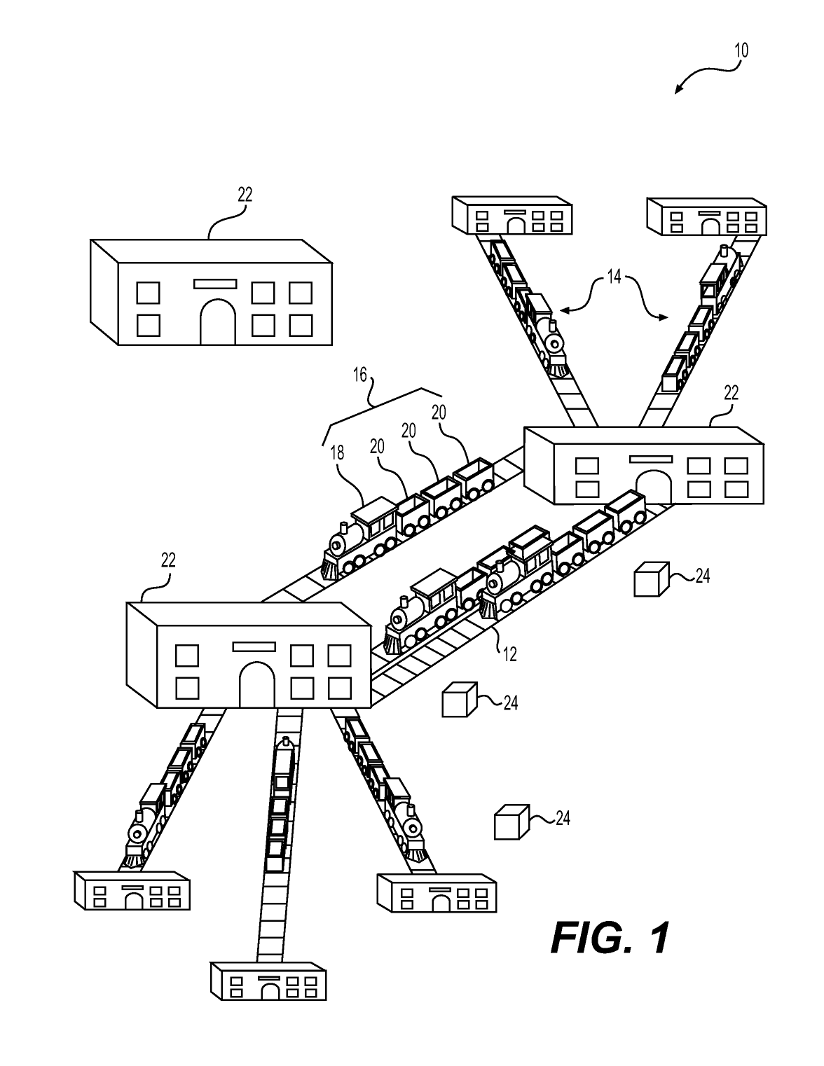

FIG. 1 schematically illustrates an exemplary railroad network 10. Railroad network 10 may include any number of tracks 12 that support a plurality of machines, such as trains 14. Tracks 12 may be, for example, railroad tracks, subway rails, trolley tracks, etc., on which trains 14 may travel. It is noted, however, that while railroad network 10 is depicted in FIG. 1 for purposes of this disclosure, other types of machine networks may be used in other embodiments. For example, in other embodiments, machine networks of individual machines (e.g., cars, haul trucks, construction machines, nautical vessels, aircraft, etc.) within certain operating boundaries (e.g., roads, waterways, airways, jobsites, etc.) may be used.

Trains 14 may each include one or more linked train assets (assets) 16 that are configured to travel in unison on tracks 12. Assets 16 may include locomotives 18, wagons 20, and/or other types of vehicles or containers that are configured to travel on tracks 12. For example, assets may include fuel-powered (e.g., diesel, natural gas, coal, etc.) locomotives, electric-powered locomotives, tender cars, passenger cars, boxcars, coal cars, tanker cars, etc. In other embodiments, assets 16 may include one or more machines operating together to complete a task, such as, for example, a group of construction machines on a jobsite, a group of haul trucks in a geographic region, a group of airplanes in a portion of airspace, etc.

A control station 22 may be located near or away from tracks 12 and used by operators and/or electronic controllers to oversee movement of trains 14 throughout railroad network 10. In some embodiments, control station 22 and/or its components may be located onboard one or more of trains 14. In other embodiments, control station 22 may be located off-board trains 14. For example, control station 22 may be located at a rail yard, a management facility, a port, or another location. Control station 22 may also or alternatively embody a computing device connected to a communication network, such as a special-purpose computer, a multi-purpose computer, a cellular phone, a tablet, or another type of stationary or portable computing device. Although only one control station 22 is illustrated in FIG. 1, it is contemplated that railroad network 10 may include any number of control stations 22, as desired.

In some embodiments, wayside equipment 24 may be positioned near or in the vicinity of tracks 12. Wayside equipment 24 may include various control devices, such as axle hot box detectors, wheel load detectors, track switches, speed restriction signs, signal lights, gates, scanners (barcode readers, RFID readers, etc.) or other devices configured to monitor and/or manage rail vehicle traffic in railroad network 10. For instance, control station 22 may send control signals to wayside equipment 24 to facilitate passage of trains 14 through railroad network 10 and receive information from wayside equipment 24 to facilitate monitoring of assets 16.

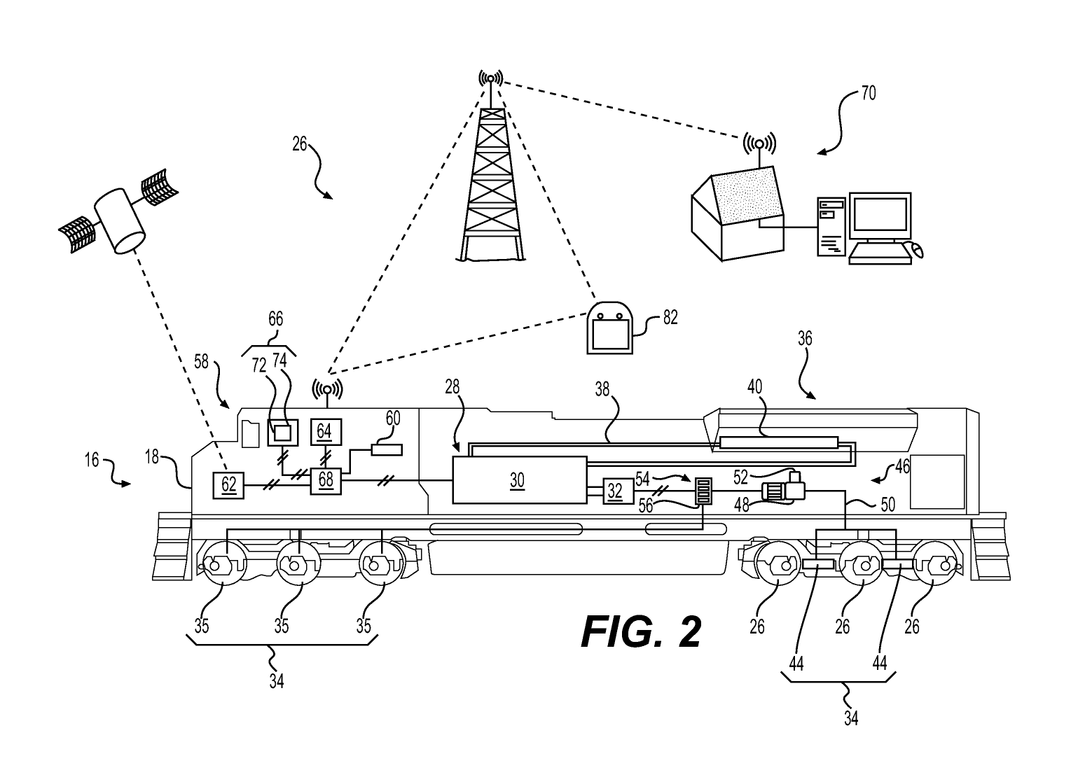

FIG. 2 shows an exemplary train asset 16 in communication with an exemplary disclosed geo-fence management system 26 that may be associated with railroad network 10 (referring to FIG. 1). For the purposes of this disclosure, asset 16 in FIG. 2 is depicted as a locomotive 18. However, it is noted that any type of asset 16, such as a wagon 20 or other equipment, such as wayside equipment 24, may be a train asset in communication with geo-fence management system 26.

Locomotive 18 may be a fuel-burning locomotive. For example, locomotive 18 may include an engine system 28 having one or more fuel-burning engines 30 (only one shown in FIG. 2). Engine 30 may be an internal combustion engine (e.g., a piston engine, a turbine engine, etc.) configured to burn a fuel (e.g., diesel, petrol, natural gas propane, kerosene, etc.) supplied by a fuel system 31 in order to generate a mechanical power output. The output of engine 30 may be used to drive a generator 32 (e.g., an AC generator, a DC generator, etc.) configured to supply electricity to a traction system 34 having one or more traction motors 35 for propelling locomotive 18 on a plurality of wheels 33 and axles (not shown). Engine 30 may alternatively be configured to directly drive wheels 33 with the mechanical output via drivetrain components, such as gears, clutches, torque converters, shafts, etc. In other embodiments, engine 30 may be a fuel-fired furnace (e.g., a coal furnace) configured to produce steam power for propelling locomotive 18.

A cooling system 36 may be configured to actively cool engine 30 and/or other components of locomotive 18. Cooling system 36 may include, for example, fluid conduits 38 that circulate a cooling fluid (e.g., water, a coolant, etc.) between a heat source (e.g., such as engine 30, generator 32, etc.) and a heat sink, such as a heat exchanger 40. Heat exchanger 40 may include a number of fluid passages configured to allow heated fluid therein to transfer heat to a cooler fluid (e.g., air, water, etc.) passing between or around the fluid passages. Cooling system may also include one or more cooling fluid pumps, valves (e.g., control valves, manual valves, etc.), fans, sensors, and/or other components.

Locomotive 18 may also include one or more brake systems 42 (only one shown in FIG. 2) configured to reduce the track speed of locomotive 18. For example, brake systems 42 may include one or more braking devices 44 positioned near a rotary component (e.g., a brake disk, brake drum, etc.). Braking devices may include a caliper and pads, shoes and linkages, magnetic brakes (e.g., eddy current brakes), or another type of braking device. As shown in FIG. 2, braking devices 44 may be actuated by a compressed air system 46. In other embodiments, braking devices may be powered hydraulically, mechanically, a combination thereof, or by another method. Locomotive 18 may also or alternatively include other types of braking systems, such as parking brakes, auxiliary brakes, electronically controlled pneumatic brakes, etc.

Compressed air system 46 may include one or more air compressors 48 (only one shown in FIG. 2) configured to pressurize air for use throughout locomotive 18. Pressurized air conduits 50 may be configured to transport pressurized air from compressor 48 to various devices within locomotive, such as braking devices 44, suspension equipment, etc. Compressor 48 may be driven by an electric motor 52 that may be powered by generator 32, a battery, or another source of electricity. In other embodiments, compressor 48 may be autonomously powered by a dedicated engine (e.g. a fuel-burning engine).

An electrical system 54 may supply and/or control electrical power to various electrical devices associated with locomotive 18. Electrical system 54 may supply electrical power via generator 32, a dedicated engine and generator, one or more batteries or battery banks, a connection to grid power, or another source of electricity. Electrical power may be distributed throughout electrical system 54 via one or more circuit breakers 56 (only one shown in FIG. 2). For example, electricity from generator 32 may be distributed to traction motors 35 via circuit breaker 56 for propelling locomotive 18. Electrical system 54 may also power a locomotive control system 5$ and/or other electronic control devices. Electrical system 54 may include additional circuit breakers, fuses, receptacles, lights (e,g., headlights, running lights, interior lights, etc.), and or other components.

Control system 58 may include one or more components associated with manual and/or automatic control of locomotive 18 and/or train 14. For example, control system 58 may include a plurality of sensors 60 (only one shown in FIG. 2), a locating device 62, a communication device 64, a user interface 66, and a controller 68 in communication with each of the other components. Controller 68 may also be in communication with and configured to selectively operate one or more actuators associated with the components of systems 28, 31, 34, 36, 42, 46, 54, and 58. Additional and/or other components of control system 58 may be included, if desired. Components of control system 58 may be configured to communicate by wired (e.g., dedicated wire, local area network (LAN), controller are network (CAN), wide area network (WAN), etc.) and/or wireless (e.g., WiFi, Bluetooth, cellular, satellite, RFID, etc.) connections.

Sensors 60 may be positioned throughout locomotive 18 and or other assets 16 of train 14 (referring to FIG. 1). Sensors 60 may each be configured to generate a signal indicative of an operating parameter and/or an operational status of an associated system, subsystem, and/or component of locomotive 18. Sensors 60 may be configured to generate signals indicative of; for example, temperature (e.g., a coolant temperature, an oil temperature, etc.), pressure (e.g., an oil pressure, a coolant pressure, an intake air pressure, etc.), position, current, voltage, presence (e.g., via optical sensors, cameras, etc,), air flow, fuel flow, exhaust constituents, air/fuel ratio, light intensity, I/O status, etc. One or more sensors 60 may be associated with each of systems 28, 31, 34, 36, 42, 46, 54, 58, and/or other systems, subsystems, and/or components of locomotive 18. Signals generated by sensors 60 may also be indicative of an operational status of sensors 60 themselves and/or their associated systems, subsystems, and/or components. For example, the integrity, strength, and/or nature of the signals generated by sensors 60 may be indicative of whether the respective sensor and/or associated systems, subsystems, and/or components are functioning properly. Signals from sensors 60 may be communicated to controller 68 for further processing.

Locating device 62 may be configured to determine and communicate an absolute and/or relative geographic location of locomotive 18. For example, locating device 62 may include a Global Positioning System (GPS) transponder configured to receive position signals from one or more GPS satellites, an Inertial Reference Unit (IRU), or any other locating device known in the art. Locating device 62 may communicate the positioning signals and/or other information to controller 68 for further processing.

Communication device 64 may include any device configured to facilitate communications between controller 68 and off-board entities, such as an off-board system 70. Communication device 64 may include hardware and/or software that enables communication device 64 to send and/or receive data messages through a wireless communication link. Communication device 64 may be configured to communicate via wireless communication platforms, such as by satellite, cellular, infrared, Bluetooth, WiFi, and/or other wireless communication platforms. Communication device may also or alternatively be configured to communicate via a local area network (LAN) or another type of wired network that enables controller 68 to exchange information with off-board entities.

User interface 66 may be located inside an operator station of locomotive 18, and may include a data entry module 72 for manually receiving data from an operator and a display 74 for displaying information to the operator. Data entry module 72 may include a keyboard, mouse, touchscreen, directional pad, selector buttons, or any other suitable features for recording manually entered data. User interface 66 may also include one or more devices for controlling operations of locomotive 18 and/or train 14. For example, user interface 66 may include'a throttle control, a brake control, a lighting control, and/or other controls. Control devices may embody levers, knobs, switches, buttons, slides, handles, touch screens, soft keys, and/or other types of controls. User interface 66 may also be configured to allow the operator to engage or communicate with train and/or train asset control systems. That is, information and requests for input from one or more control systems may be shown to the operator via display 74, and the operator may provide responses and/or other input via data entry module 72. Inputs entered via data entry module may be communicated to controller 68 for further processing.

Offboard system 70 may represent one or more computing systems associated with railroad network 10, control station 22, assets 16 (e.g., locomotives 18, wagons 20, wayside equipment 24, etc.), and/or other components of railroad network 10. Off-board system 70 may be configured to allow a user to engage control systems associated with trains 14 and/or train assets 16 in railroad network 10. Information and requests for input from one or more train and/or train asset control systems may be shown to the user via offboard system 70. Offboard system 70 may also be configured to allow the user to provide responses and/or other inputs to train and/or train asset control systems. Off-board system 70 may embody, for example, one or more laptop computers, work stations, personal digital assistants, mainframes, cellular phones, tablets, computerized accessories (e.g., pair of glasses, a watch, etc) and/or other computing systems known in the art.

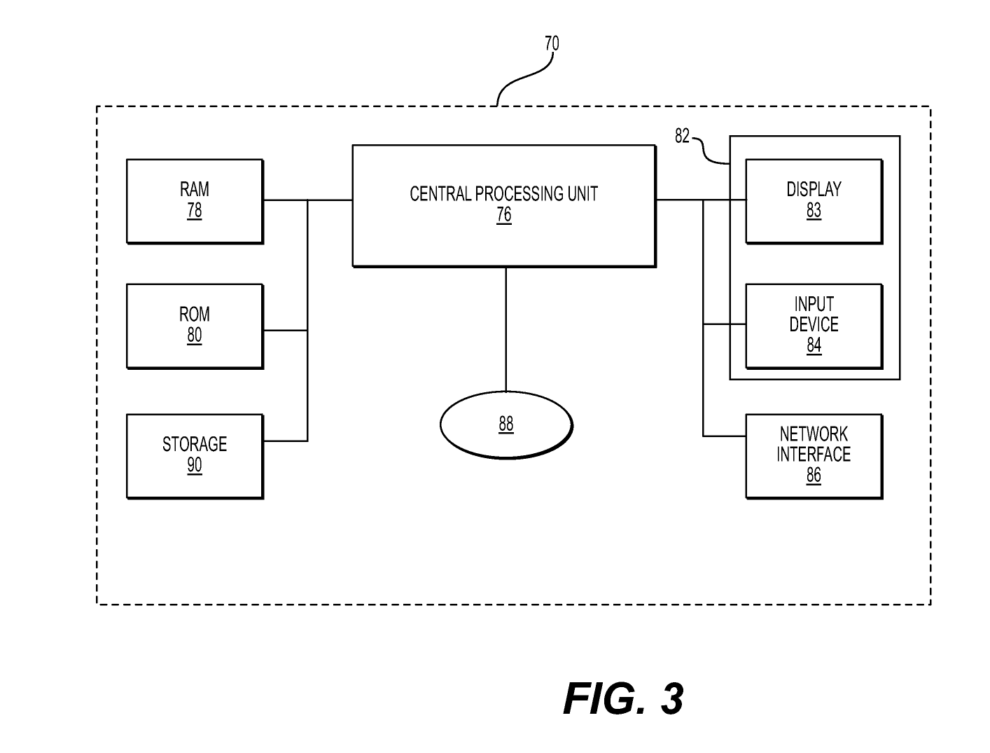

As shown in FIG. 3, off-board system 70 may include a central processing unit (CPU) 76, a random access memory (RAM) 78, a read-only memory (ROM) 80, one or more user interfaces 82 (only one user interface 82 shown in FIG. 3), a display 83, an input device 84, a network interface 86, a database 88 and storage 90. It is contemplated that offboard system 70 may include additional, fewer, and/or different components than those listed above. It is to be understood that the type and number of listed devices are exemplary only and not intended to be limiting.

CPU 76 may embody, for example, one or more specially-constructed or generic microprocessors configured to execute sequences of computer program instructions to perform various processes in connection with geo-fence management system 26. The computer program instructions may be loaded into RAM 78 for execution by CPU 76 from ROM 80. During operation, CPU 76 and/or controller 68 may cooperate via communication device 64 to carry out various processes in connection with geo-fence management system 26.

Storage 90 may embody any appropriate type of mass storage provided to store information that CPU 76 and/or controller 68 may access to perform various processes. For example, storage 90 may include one or more hard disk devices, optical disk devices, removable memory devices, solid state memory devices, flash memory devices, and/or other storage devices.

Off-board system 70 may be configured to interface with a user via user interface 82. User interface 82 may include a display 83 and input device 84. For example, user interface 82 may display information to users of off-board system 70 via display 83 and receive user inputs via input device 84. User interface 82 may be any appropriate type of display device, such as a computer monitor, laptop screen, cellular phone screen, etc. Input device 84 may include, for example, a keyboard, a mouse, a touch screen, buttons, soft keys, and/or other wired or wireless user interfaces known in the art.

Network interface 86 may facilitate wireless and/or wired communications such that off board system 70 may be remotely accessed by controller 68 and/or other off-board systems (not shown). Network interface 86 may include and/or be associated with any suitable wired and/or wireless network architecture, such as, for example, a cellular telephone-based network (such as a PBX or POTS), a satellite-based network, LAN, WAN, CAN, a dedicated intranet, the Internet, and/or any other suitable network architecture known in the art.

Database 88 may contain, among other things, information relating to each train 14, information relating to each asset 16, and/or information relating to operating conditions, operational states, and geo-fence parameters for each asset 16. For example, database 88 may store an up-to-date list of every train 14 and associated asset 16 operating in railroad network 10. Database 88 may also store an up-to-date list of every system (e.g., systems 28, 31, 34, 36, 42, 46, 54, and 58) and/or component associated with each asset 16 and known data associated with each asset 16. For example, database 88 may store the latest information for each asset 16, such as, for example, a name, a serial number, a software version number, a system list, a component list, a part number list, and/or a date of manufacture for the asset. The train information and asset information may be kept current by, for example, automatic or manual electronic updates and/or by an authorized user of off-board system 70.

The information contained in database 88 may include operational and/or diagnostic information that can be used to control and/or establish geo-fences for each asset 16 and/or associated systems and components. For example, the operational and/or diagnostic information may include variables and parameter thresholds for automatic control strategies (e.g., threshold temperatures, pressures, fluid levels, times, etc.) and tables of fault codes and associated alert triggering mechanisms. Triggering mechanisms may include sensor signal criteria (e.g., strength, integrity, on/off, etc.), operating parameter thresholds, and or other triggers. Each fault code may correspond to or be indicative of an issue pertaining to a type of asset, an asset system, a system component, or maintenance aspect. Triggering mechanisms may be monitored or detected via sensors 60, wayside equipment 24, off-board personnel via a remote device (e.g., user interface 82), and/or other diagnostic devices.

It should also be noted that a different number and/or different types of databases may be included within off-board system 70 and utilized by CPU 76, if desired. It is further contemplated that the information described above as being stored in database 88 may additionally or alternatively be stored within the memory of CPU 76 or elsewhere in off-board system 70, if desired. At least some of the information described as contained within database 88 may be additionally or alternatively stored on controller 68, if desired.

Controller 68 (referring to FIG. 2) may embody, for example, an electronic control module (ECM), or another processor capable of executing, and/or or outputting control signals in response to received and/or stored data. Controller 68 may include means for accessing, reading, and processing stored information and for displaying such information by way of user interface 66 and/or 82. For example, controller 68 may embody a single microprocessor or multiple microprocessors that include a means for monitoring input from user interfaces 66, 82, and/or sensors 60. Controller 68 may include a memory, a secondary storage device, and a processor, such as a central processing unit or any other means for accomplishing a task consistent with the present disclosure. Commercially available microprocessors can be configured to perform the functions of controller 68. It should be appreciated that controller 68 could readily embody a general machine controller capable of controlling numerous other machine functions. Various other known circuits may be associated with controller 68, including signal-conditioning circuitry, communication circuitry, and other appropriate circuitry.

Controller 68 may be configured to continually receive signals from sensors 60 and automatically generate control signals based on the signals from sensors 60. For example, controller 68 may control operations of assets 16 according to a feedback control strategy. That is, controller 68 may monitor operating parameters of assets 16 (as indicated by signals from sensors 60) and generate control signals to actuate components of assets 16 in order to maintain the operating parameters at or within a range of set point and/or threshold values. Controller 68 may control actuators associated with operating parameters, such as, for example, engine speed, fuel pressure, coolant temperature, and/or others, based on a stored control strategy and signals from respective associated sensors 60 in order to maintain each operating parameter within a desired working range.

In some situations, train 14 may travel through several different geographic regions and encounter different operating conditions in each region. For example, different regions may be associated with varying track conditions, steeper or flatter grades, speed restrictions, noise restrictions, and/or other such conditions. Some operating conditions in a given geographic region may also change over time as, for example, track rails wear and speed and/or noise restrictions are implemented or changed. Other circumstantial conditions, such as distances between sidings, distances from rail yards, limitations on access to maintenance resources, and other such considerations may vary throughout the course of mission. Operators may therefore wish to implement certain control parameters in certain geographic regions to address particular operating conditions. To help operators implement desired control strategies based on the geographic location of train 14, controller 68 may be configured to allow operators and/or other users to establish and define the parameters of geo-fences along a travel route.

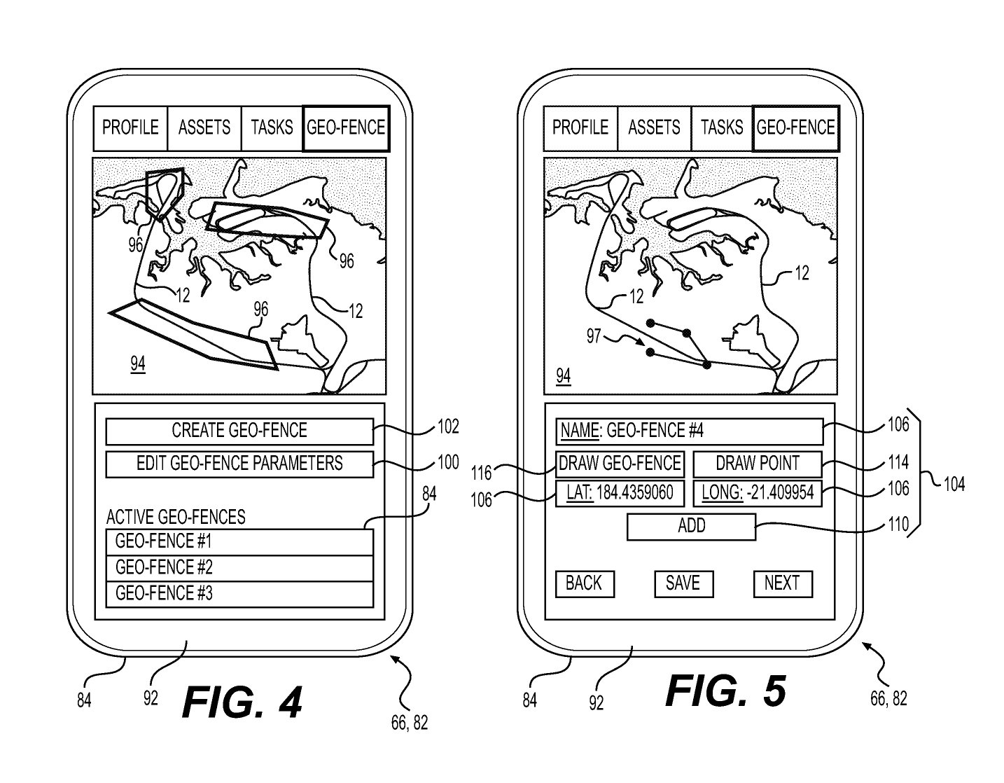

For example, as shown in FIG. 4, user interface 66, $2 may include a GUI 92 configured to display information and receive user inputs associated with train 14. GUI 92 may be a graphic display tool including menus (e.g., drop-down menus), modules, buttons, soft keys, toolbars, text boxes, field boxes, windows, and other means to facilitate the conveyance and transfer of information between a user and off-board system 70 and/or controller 68 (referring to FIG. 2). It is to be appreciated that controller 68 may require user authentication, such as, for example, a username, a password, a pin number, an electromagnetic passkey, etc., to display certain information and/or functionalities of GUI 92.

Controller 68 may be configured to display via GUI 92 a map 94 of at least a portion of railroad network 10. For example, map 94 may be configured to show sections of tracks 12 in relation to certain geographic features (e,g., portions of land, bodies of water, etc.), towns, rail yards, and/or other features. Map 94 may also be indicative of other geographic information, such as topographic data, grades of tracks 12, elevation, and or other information. In some embodiments, map 94 may show nearby buildings, airports, roadways, waterways, and/or other features, if desired,

Controller 68 may be configured to show via map 94 graphical representations of one or more existing geo-fences 96. Graphical representations of existing geo-fences 96 may be represented by any suitable form of indicia, such as a single line, multiple connected lines, shaded regions, or combinations thereof. In some embodiments, names or other identifying insignia for each existing geo-fence 96 may be shown near each existing geo-fence 96 on map 94. A list 98 of existing geo-fences 96 may also be displayed on GUI 92 and include each geo-fence shown on map 94 at any given moment as well as existing geo-fences 96 not shown on map 94.

Map 94 may be user-interactive and configured to allow users to manipulate and/or select features of map 94 by engaging map 94 via GUI 92. For example, map 94 may be movable, expandable, shrinkable, rotatable, etc., in response to the user's selection of associated features, such as scroll bars, scroll buttons, drag-and-drop functionality, and/or other features. Features shown on map 94, such as existing geo-fences 96, may be selected, for example, by clicking on, touching, or otherwise engaging features as they appear on map 94 via GUI 92. Once a feature on map 94 has been selected, the appearance of the selected feature may indicate that it has been selected, for example, by becoming highlighted, bolded, or otherwise altered in appearance in order to indicate that it has been selected.

List 98 may also be user-interactive and configured to allow users to manipulate and/or select features of list 98 by engaging list 98 via GUI 92. List 98 may be scrollable (e.g., via scroll buttons, a scroll bar, selectively movable, etc.) to allow the user to browse through any number of existing geo-fences 96 shown or not shown on map 94. Each existing geo-fence 96 in list 98 may be selectable by engaging GUI 92 (e.g., by touching, clicking, etc.). Selections of existing geo-fences 96 in list 98 may correspond to selections of existing geo-fences 96 shown on map 94. For example, when a user selects an existing geo-fence 96 via map 94, the selected geo-fence 96 may become highlighted or otherwise indicate its selection in list 98. Similarly, a selection of an existing geo-fence 96 in list 98 may cause the selected geo-fence 96 to become highlighted or otherwise indicate its selections on map 94.

User interface 66,82 may be configured to receive via input device 84 a user selection of an option to edit an existing geo-fence 96 or an option to create a new geo-fence 97 (shown only in FIG. 5) via one or more features of GUI 92. That is, existing geo-fences 96 may be edited and new geo-fences 97 may be created by the user in conjunction with map 94, list 98, and/or other features of GUI 92. For example, GUI 92 may include a button 100 configured to receive an input from the user indicative of a desire to edit an existing geo-fence 96. In some embodiments, button 100 may be configured to allow a user to edit an existing geo-fence 96 selected by the user via map 94 or list 98. In other embodiments, the user's selection of an existing geo-fence 96 to be edited may follow the user's selection of button 100. GUI 92 may also include a button 102 configured to receive an input from the user indicative of a desire to establish a new geo-fence 97, it is understood that GUI 92 may include other features instead, of or in addition to buttons 100, 102 that are configured to receive an input indicative of a desire to edit a geo-fence.

User interface 66, 82 may be configured to receive via input device 84 information relating to the creation or modification of new and existing geo-fences 97, 96. Such information may include, for example, a first input indicative of geographic information, a second input indicative of an operating parameter of the train 14 associated with the geographic information, and a third input indicative of one or more of a task and a request to monitor data associated with the operating parameter of train 14. Controller 68 may configured to then edit the selected existing geo-fence 96 or create a new geo-fence 97 in conjunction with one or more of the first, second, and third inputs based on the user selection.

For example, as shown in FIG. 5, upon receiving the input via GUI 92 indicative of the user's desire to edit existing geo-fence 96 (shown only in FIG. 4) or create new geo-fence 97, controller 68 (referring to FIG. 2) may be configured to display via GUI 92 one or more graphical objects 104 configured to receive an input from the user indicative of geographic information. Graphical objects 104 may include, for example, one or more text fields 106 and buttons 110, 114, 116. Text fields 106 may be configured to display and/or receive data relating to geographic information. Geographic information may include GPS coordinates, map grid coordinates, or another type of information that may be used to define a geographic location. When the user selects an existing geo-fence 96 (referring to FIG. 4) to edit, information about the existing geo-fence 96, such as its name, coordinate information, and/or or other information may be displayed in text fields 106. The information initially displayed in text fields 106 may be edited by the user via input device 84. When the user elects to create new geo-fence 97, text fields 106 may initially be empty until the user enters information via input device 84.

Buttons 110, 114, 116 may be configured to allow the user to enter geographic information by creating boundaries of existing or new geo-fences 96, 97. For example, first button 110 may be configured to initiate the creation by controller 68 of coordinate points 112 based on coordinate information entered into one or more of text fields 106. Coordinate points 112 may be displayed on map 94 upon the selection of first button 110 to allow the user to visualize the relative size, shape, and location of new geo-fence 97. Although only new geo-fence 97 is shown on map 94 in FIG. 5, it is contemplated that when the user selects an existing geo-fence 96 (referring to FIG. 4) to edit, the selected existing geo-fence 96 may be displayed on map 94 and its appearance automatically updated When its coordinate information is altered (e.g., by changing existing coordinate point information or adding new coordinate points 112). When existing geo-fence 96 is shown, its coordinate points 112 may be selectable to allow the user to edit a particular point. For example, selection of a coordinate point 112 may cause controller 68 to fill text fields 106 with the coordinate information of the selected coordinate point 112 for editing.

Controller 68 may also or alternatively be configured to generate on GUI 92 second button 114 or another feature configured to allow the user to generate coordinate information in text field 106 by selecting a point on map 94. That is, when second button 114 is selected, controller 68 may determine coordinate information for a point on map 94 when it is selected by the user via input device 84. In this way, the user may be allowed to quickly and easy create coordinate points 112 for existing and new geo-fences 96, 97. Coordinate point information and/or other geographic data may be stored within the memory of controller 68, in an associated data storage device, or accessible by controller 68 through locating device 62. Controller 68 may be configured to associate coordinate information with the existing or new geo-fence 96, 97 based on the user's input in conjunction with the stored geographic data.

Controller 68 may also or alternatively be configured to generate on GUI 92 third button 116 or another other feature configured to allow the user to draw new geo-fence 97 directly on map 94 via GUI 92 and input device 84. For example, selection of third button 116 may permit the user to draw new geo-fence 97 by dragging a finger, stylus, or other object across input device 84 to create new geo-fence 97. It is understood that other ways of drawing new geo-fence 97 using input device 84, such as by clicking-and-dragging a pointer, operating directional pads, manipulating joysticks, and/or other methods may be used. As the user draws on map 94, controller 68 may show a graphical representation of existing or new geo-fence 96, 97 via GUI 92 based on the user's input drawing. Controller 68 may be configured to associate coordinate information with the existing or new geo-fence 96, 97 based on the user's input drawing in conjunction with stored geographic data within its memory, an associated data storage device, or accessible by controller 68 through locating device 62.

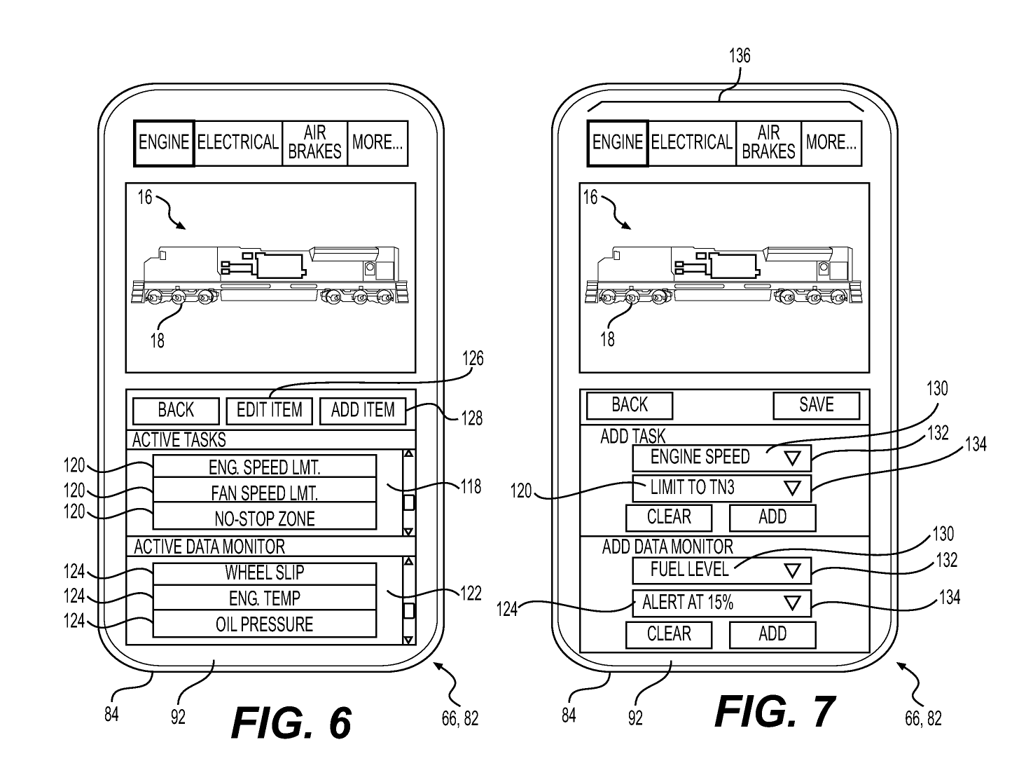

As shown in FIG. 6, controller $8 (referring to FIG. 2) may be configured to display via GUI 92 a list 118 of active tasks 120 and/or a list 122 of active requests to monitor data (data monitors) 124 associated with existing or new geo-fence 96, 97 (referring to FIGS. 4 and 5). When the user has chosen to edit existing geo-fence 96, list 118 may display active tasks to be carried out by controller 68 in association with existing geo-fence 96. List 118 may include active tasks 120 that instruct controller 68 to, for example, limit the engine speed of locomotive 18, limit the fan speed of locomotive 18, and prevent train 14 from stopping within the geographic area of the geo-fence. It is understood that additional or other tasks 120 associated with automatic control of train 14 may be included, as desired. List 118 may be scrollable to allow the user to browse any number of tasks 120 that are active.

List 122 may include data monitors 124 that represent user requests for controller 68 to monitor certain operating parameters of train 14 in association with the geo-fence. Operating parameters, such as wheel slip, engine temperature, oil pressure, and/or other parameters may be specifically monitored and the user notified by controller 68 When the monitored parameters exceed a particular threshold. It is understood that additional or other data monitors 124 associated with automatic and/or manual control of train 14 may be included, as desired. List 122 may be scrollable to allow the user to browse any number of data monitors 124 that are active. When the user is creating new geo-fence 97, lists 118 and 122 may initially be empty.

When the user desires to edit an active data monitor 124 or add a new task 120 or data monitor 124 to lists 118 and 122, respectively, the user may select one of an edit button 126 or an add button 128 displayed on GUI 92 by controller 68. To edit a task 120 or data monitor 124, the user may select a task 120 or data monitor 124 from lists 118 or 122, respectively, and then select the edit button 126 to continue. To create a new task 120 or data monitor 124, the user may select the add button 128 to continue. It is understood that buttons 126 and 128 may be other types of graphical objects, if desired.

As shown in FIG. 7, user interface 66, 82 may be configured to receive a second input from the user indicative of an operating parameter 130 of train 14 (referring to FIG. 1). One or more operating parameters 130 may be received via GUI 92, each being associated with task 12.0 or data monitor 124. For example, GUI 92 may include one or more graphical objects 132 configured to provide a selectable list of operating parameters 130, such as engine speed, fan speed, track speed, fuel level, oil pressure, coolant temperature and/or other operating parameters 130. Each selected operating parameter 130 may be associated with the geographic information previously entered by the user in that controller 68 may be configured to store in its memory the selected operating parameter 130 in association with the entered geographic information. Controller 68 may then be configured to generate command signals for controlling and/or monitoring train 14 based on the operating parameters 130 and geographic information.

User interface 66, 82 may be configured to receive the third input indicative of one or more of a task. 120 and a data monitor 124 associated with operating parameter 130 via GUI 92. For example, controller 68 may be configured to display via GUI 92 one or more graphical objects 134 configured to provide a selectable list of tasks 120 or data monitors 124 that are selectable in conjunction with operating parameters 130. Tasks 120 may include control operations, such as limiting the selected operating parameter, such as engine speed, fan speed, etc., based on a particular operating parameter threshold (e.g., a threshold speed, a threshold temperature, a threshold pressure, etc.). Data monitors 124 may establish conditions for controller 68 to alert the operator when the associated operating parameter 130 reaches an operating parameter threshold. For example, data monitors 124 may include instructions to alert the operator when the associated operating parameter 130 reaches a particular value, such as a fill level threshold, a temperature threshold, a pressure threshold, etc. Controller 68 may also store received data monitors 124 in its memory and generate command signals for controlling and/or monitoring train 14 based on operating parameters 130, tasks 120 and/or data monitors 124, and associated geographic information.

User interface 66, 82 may also be configured to receive a user selection of one of a plurality of systems 136 associated with locomotive 18 and display graphical objects 132, 134 in conjunction with the user selection. For example, the user may select one of systems 136, such as an engine system, an electrical system, a brake system, or another type of system, and controller 68 may populate graphical objects 132, 134 with operating parameters and tasks 120 or data monitors 124, respectively, based on the selected system 136. Controller 68 may store within its memory one or more operating parameters 130, tasks 120, and data monitors 124 for each system 136 that may be associated with the user input received via graphical objects 132, 134.

Graphical objects 132, 134 may each be one of a text field configured to receive a user entry and a menu containing one or more selectable entries. For example, graphical object 132 may be a menu containing operating parameters associated with one or more of train 14, locomotive 18, and/or the selected system 136 of locomotive 18. Graphical object 134 may be a menu containing tasks 120 or data monitors 124 associated with one or more of train 14, locomotive 18, and/or the selected system 136 of locomotive 18.

In some embodiments, user interface 66, 82 may be configured to receive via communication device 64, sensors 60, and/or controller 68 operational information indicative of one or more of geographical information, an operating parameters 130, tasks 120, and data monitors 124. User interface 66, 82 may be configured to display one or more of graphical objects 132, 134 in conjunction with the received operational information. For example, controller 68 may receive signals from sensors 60 and generate one or more tuft codes based on the signals from sensors 60. The fault codes may be indicative of one or more operating parameters 130 that have exceeded an associated operating parameter threshold. Controller 68 may also be configured to store geographical information (e.g., the GPS location of train 14 or asset 16) in conjunction with the fault code. Controller 68 may be configured to populate graphical objects 132 with the operating parameters associated with generated fault codes to allow the user to establish a task 120 or data monitor 124 based on the associated operating parameter 130. When the user establishes tasks 120 or data monitors 124 based on operating parameters 130 associated with the generated fault codes, the stored geographic information may be automatically associated with existing or new geo-fence 96, 97. In this way, accurate geo-fence boundaries may be established quickly and easily.

In some embodiments, operational information from off-board entities, such as off-board personnel, may be received by controller 68 via communication device 64. Such operational information may include messages containing track information, posted or unposted restrictions, fault codes, instructions, maintenance information, or other operational information. Each message may include operating parameters 130, tasks 120, data monitors 124, and/or associated operating parameter thresholds that are each associated with stored geographic information. The associated geographic information may be indicative of, for example, the location of a track issue (e.g., slick tracks), the location of an applicable speed or noise limit, or the location of an area when a certain operating parameter 130 should be monitored. Controller 68 may be configured to populate graphical objects 132 with the operating parameters associated with generated fault codes to allow the user to establish a task 120 or data monitor 124 based on the associated operating parameter 130. When the user establishes tasks 120 or data monitors 124 based on operating parameters 130 associated with the received messages, the stored geographic information may be automatically associated with existing or new geo-fence 96, 97. In this way, accurate geo-fence boundaries may be established quickly and easily from information generated off-board train 14.

Once the first, second, and third inputs are received from the user via GUI 92, controller 68 may be configured generate command signals in conjunction with a geo-fence at least partially defined by the geographic information, operating parameters 130, tasks 120, data monitors 124, and/or the associated operating parameter thresholds. That is, controller $8 may be configured to control the selected operating parameters 130 according to the selected task and associated operating parameter threshold when train 14 is within the geographic boundaries of existing or new geo-fence 96, 97 (referring to FIGS. 4 and 5). Controller 68 may also be configured to monitor the selected operating parameters 130 according to the selected data monitor 124 and associated operating parameter threshold when train 14 is within the geographic boundaries of existing or new geo-fence 96, 97 (referring to FIGS. 4 and 5).

Controller 68 may also be configured to generate any of the above described information for display on a mobile electronic device. For example, when user interface 66, 82 is a mobile electronic device, such as a mobile computer, personal digital assistant, cellular phone, tablet, computerized watch, computerized glasses, etc., GUI 92 may be limited in size as compared to when user interface 66, 82 is associated with, for example, a personal computer, laptop, work station, etc. To allow users to quickly browse through available information and selection options, controller 68 may display any of the above described information in conjunction with labeled widows or tabs, scroll bars, swipe-able graphics, or other computer-implemented functionality.

One skilled in the art will realize that the processes illustrated in this description may be implemented in a variety of ways and include other modules, programs, applications, scripts, processes, threads, or code sections that may all functionally interrelate with each other to accomplish the individual tasks described above for each module, script, and daemon. For example, these programs modules may be implemented using commercially available software tools, using custom object-oriented code written in the C++ programming language, using applets written in the Java programming language, or may be implemented with discrete electrical components or as one or more hardwired application specific integrated circuits (ASIC) that are custom designed for this purpose. Other programming languages may be used as desired.

The described implementation may include a particular network configuration but embodiments of the present disclosure may be implemented in a variety of data communication network environments using software, hardware, or a combination of hardware and software to provide the processing functions.

### INDUSTRIAL APPLICABILITY

The disclosed geo-fence management system may be applicable to any transportation network, including subways, trolleys, and railroads. The disclosed geo-fence management system may increase efficiency in editing and creating new geo-fences for automatic control and monitoring of machines. In particular, the disclosed geo-fence management system may allow a user to easily select an existing geo-fence to edit or create a new geo-fence from an interactive map on a mobile electronic device. The disclosed geo-fence management system may also allow users to quickly and easily select desired operating parameters and associated thresholds for automatically controlling and/or monitoring machines within the geo-fence. Further, the disclosed geo-fence management system may allow users to quickly and easily create geo-fences with associated control and monitoring functions based on information imported from other electronic devices. An exemplary operation of the disclosed geo-fence management system will now be explained.

During operation of asset 16 associated with train 14 on railroad network 10, controller 68 may receive signal(s) from sensors 60 indicative of operational information of asset 16 or its associated systems, subsystems, and/or components. For example, a signal generated by one of sensors 60 may be indicative of, for example, a coolant temperature, an oil temperature, an oil pressure, a wheel slip condition, or another operating parameter of asset 16. Controller 68 may automatically generate machine control signals for controlling the operations of train 14 and its assets 16 based on the signals from sensors 60 and operating parameter thresholds stored within its memory or an associated storage device.

With reference to FIGS. 4 and 5, when an operator wishes to modify the automatic control strategy of controller 68 or monitor certain operating parameters of asset 16, the user may edit an existing geo-fence 96 or create a new geo-fence 97 via GUI 92 of user interface 66, 82. To edit existing geo-fence 96, the user may choose existing geo-fence 96 by selecting it on map 94 or from list 98 of existing geo-fences 96.

User interface 66, 82 may then receive from the user via GUI 92 the first input indicative of geographic information. For example, user interface 66, 82 may receive from the user via text fields 106 latitude and longitudinal coordinates for one or more coordinate points 112. The user may then select first button 110 to cause each point to be displayed on map 94. The user may also or alternatively select second button 114, thereby enabling the user to draw coordinate points 112 direction onto map 94. The drawn coordinate points 112 may be automatically shown on map 94 in response to the touch of the operator (or other input via input device 84), or geographic data for each drawn coordinate point 112 may be displayed in text fields 106 and displayed When first button 110 is subsequently selected.

The user may also or alternatively select third button 116, thereby enabling the user to draw new geo-fence 97 directly on map 94 via GUI 92. When third button 116 is selected, the user may be allowed to draw with a finger or other aspect of input device 84 new geo-fence 97 without entering specific coordinate points. In this way, the user may be allowed to quickly easily establish new geographic boundaries for geo-fences. Controller 68 may then save any geographic information received via user interface 66, 82 for further processing.

Referring to FIGS. 6 and 7, when existing geo-fence 96 (referring to FIG. 4) is selected to be edited by the user, active tasks 120 and active data monitors 124 associated with existing geo-fence 96 may be displayed in lists 118 and 122, respectively. The user may scroll through lists 118, 122 and select one of tasks 120 and data monitors 124 for editing via input device 84 and GUI 92 and confirm the selection via edit button 126. When the user wishes to add a new task 120 or data monitor 124 or is establishing new geo-fence 97 and no tasks 120 or data monitors 124 have been created yet, the user may select add button 128.

User interface 66, 82 may then receive the second input from the user indicative of operating parameter 130 associated with the received geographic information. When the user has selected an active task 120 or data monitor 124 to edit, controller 68 may prefill graphical objects 132 with the operating parameter 130 associated with the selected active task 120 or data monitor 124 to be edited. When the user wishes to create a new task 120 or data monitor 124, controller 68 may pre-fill graphical objects 132 with one or more operating parameters 130 that may be selected by the user. Operating parameters 130 selectable by the user may include any operating parameter monitored by one of sensors 60 (referring to FIG. 2). In some embodiments, operators may enter operating parameters 130 by typing relevant information into graphical objects 132 via input device 84.

User interface 66, 82 may also receive the third input from the user indicative of one or more of task 120 and data monitor 124 associated with the selected operating parameter 130. When the user has selected an active task 120 or data monitor 124 to edit, controller 6$ may prefill graphical objects 134 with the task 120 or data monitor 124 associated with the selected active task 120 or data monitor 124 to be edited. When the user wishes to create a new task 120 or data monitor 124, controller 68 may prefill graphical objects 134 with one or more tasks 120 or data monitors 124 that may be selected by the user. In some embodiments, operators may enter tasks 12 and/or data monitors 12.4 by typing relevant information into graphical objects 134 via input device 84.

Tasks 120 selectable by the user may include operational tasks, such as limiting the associated operating parameter 130, maintaining a minimum value of the associated operating parameter 130, changing the I/O status of one or more components of asset 16, etc. It is understood that other tasks 120 may be available for selection, as desired. Data monitors 124 selectable by the user may include a request to monitor the associated operating parameter 130 when train 14 is within the geographic boundaries at least partially defined by the first input from the user. Data monitors 124 may also include a request to alert the operator when the associated operating parameter 130 reaches a particular threshold.

In some embodiments, the user may select a system 136 associated with asset 16 via GUI 92, and controller 68 may display graphical objects 132, 134 in conjunction with the user selection. That is, controller 68 may populate graphical objects 132, 134 with operating parameters and tasks 120 or data monitors 124, respectively, that are associated with the selected system 136 to allow the user to quickly and efficiently browse through selectable operating parameters, tasks 120, and data monitors 124. In some embodiments, a graphical representation of each system 136 may be shown via GUI 92 to allow the user to quickly visualize select a particular system 136. Graphical representations of each system 136 that is associated with a fault code or operational information received from offboard train 14 may be indicative of the association, such as by being displayed in a particular color or with another identifying feature.

In some embodiments, controller 68 may populate graphical objects 132, 134 with selectable options based on operational information received in conjunction with sensors 60 or from offboard entities, such as off-board personnel, via communication device 64. The operational information received may include fault codes and/or messages intended to provide the operator with information for generating geo-fences in response to detected issues. The messages may include predetermined operating parameters 130, tasks 120, data monitors 124, and/or associated operating parameter thresholds associated with particular geographic information. Controller 68 may receive these messages, extract relevant data, and prefill graphical objects 132, 134 with the predetermined options for selection by the user.

Once the first, second, and third inputs are received from the user from user interface 66, 82 and via GUI 92, controller 68 may then generate command signals in conjunction with the edited existing or new geo-fence 96, 97 at least partially defined by the geographic information, operating parameters 130, tasks 120, data monitors 124, and/or the associated operating parameter thresholds. That is, controller 68 may be configured to automatically control or monitor aspects of train 14 based on and/or according to the first, second, and third inputs when train 14 is within the geographic boundaries of the existing or new geo-fence 96, 97.

Several advantages may be realized by the implementation of geo-fence management system 26. By using geo-fence management system 26, train operators and managers of railroad network 10 may be able to quickly and easily edit existing geo-fences 96 or establish new geo-fences 97 from onboard or off-board train 14. By using geo-fence management system 26, operators and users may be able to quickly modify or establish geographic boundaries, tasks 120, and/or data monitors 124 for geo-fences via an interactive and visual user interface 66, 82, thereby reducing errors and time spent in changing or creating geo-fences.

It will be apparent to those skilled in the art that various modifications and variations can be made to the geo-fence management system of the present disclosure. Other embodiments of the method and system will be apparent to those skilled in the art from consideration of the specification and practice of the geo-fence management system disclosed herein. It is intended that the specification and examples be considered as exemplary only, with a true scope of the disclosure being indicated by the following claims and their equivalents.

What is claimed is:

1. A geo-fence management system for a machine, comprising:
a user interface having a display device and an input device, wherein the user interface is configured to receive via the input device:
a first input indicative of geographic information;
a second input indicative of an operating parameter of the machine associated with the geographic information; and
a third input indicative of one or more of a task and a request to monitor data associated with the operating parameter of the machine; and
a controller in communication with the user interface and configured to generate a command signal based on one or more of the first, second, and third inputs,

2. The geo-fence management system of claim 1, wherein:
the user interface is configured to receive a user selection of one of an option to edit an existing geo-fence and an option to create a new geo-fence; and
the controller is configured to edit the existing geo-fence or create the new geo-fence in conjunction with one or more of the first, second, and third inputs based on the user selection.

3. The geo-fence management system of claim 2, wherein the user interface is configured to display a graphical representation of the existing geo-fence, the graphical representation of the existing geo-fence being selectable in conjunction with the option to edit the existing geo-fence.

4. The geo-fence management system of claim 1, wherein the user interface is configured to:
display a map via the display device; and
receive the first input via a user selection of a portion of the map.

5. The geo-fence management system of claim 1, wherein user interface is configured to receive the first input via a user entry of one or more geographic coordinates.

6. The geo-fence management system of claim 1, wherein the user interface is configured to:
receive a user selection of one of a plurality of systems associated with the machine; and
display a graphical object in conjunction with the user selection, the graphical object being configured to receive the second input.

7. The geo-fence; management system of claim 6, wherein the graphical object is one of a text field and a menu containing one or more operating parameters associated with the selected system.

8. The geo-fence management system of claim 1, wherein:
the third input includes a selection of an operating parameter threshold; and
the controller is configured generate the command signal in conjunction with a geo-fence at least partially defined by the geographic information and the operating parameter threshold.

9. The geo-fence management system of claim 1, wherein:
the third input includes a selection of an operating parameter threshold; and
the controller is configured to monitor the operating parameter indicated by the second input and generate an alert via the user interface in conjunction with a geo-fence at least partially defined by the geographic information and the operating parameter threshold.

10. The geo-fence management system of claim 1, further comprising one or more of a communication device and a plurality of sensors wherein:
the controller is in communication with the one or more of the communication device and the plurality of sensors and configured to receive operational information via the plurality of sensors or the communication device, the operational information being indicative of one or more of geographical information, an operating parameter, a task, and a request to monitor data; and
the user interface is configured to display one or more graphical objects in conjunction with the operational information, the one or more graphical objects being configured to receive one or more of the second and third inputs.

11. A method of operating a geo-fence management system having a user interface, the method comprising:
receiving via the user interface:
a first input indicative of geographic information;
a second input indicative of an operating parameter of a machine associated with the geographic information; and
a third input indicative of one or more of a task and a request to monitor data associated with the operating parameter of the machine; and
generating a command signal to control the machine based on one or more of the first, second, and third inputs,

12. The method of claim 11, further including:
receiving via the user interface a user selection of one of an option to edit an existing geo-fence and an option to create a new geo-fence; and
one of editing the existing geo-fence or creating the new geo-fence, in conjunction with one or more of the first, second, and third inputs, based on the user selection,

13. The method of claim 12, further including displaying a graphical representation of the existing geo-fence via the user interface, the graphical representation of the existing geo-fence being selectable in conjunction with the option to edit the existing geo-fence.

14. The method of claim 11, further including:
displaying a map via the user interface; and
receiving a user selection of a portion of the map via the user interface.

15. The method of claim 11, further including receiving a user entry of one or more geographic coordinates via the user interface,

16. The method of claim 11, further including:
receiving via the user interface a user selection of one of a plurality of systems associated with the machine; and
displaying a graphical object via the user interface in conjunction with the user selection, the graphical object being configured to receive the second input, wherein the graphical object is one of a text field and a menu containing one or more operating parameters associated with the selected system.

17. The method of claim 11, further including:
receiving a selection of an operating parameter threshold via the user interface; and
generating the command signal in conjunction with the operating parameter threshold.

18. The method of claim 11, further including:
receiving a selection of an operating parameter threshold via the user interface; and
monitoring the operating parameter indicated by the second input and generating an alert via the user interface based on the operating parameter threshold.

19. The method of claim 11, further including:
receiving operational information via a sensor or a communication device, the operational information being indicative of one or more of geographical information, an operating parameter, a task, and a request to monitor data; and
displaying one or more graphical objects via the user interface in conjunction with the operational information, the one or more graphical objects being configured to receive one or more of the second and third inputs.

20. A geo-fence management system for a machine, comprising:
a user interface having a display device and an input device, wherein the user interface is configured to receive via the input device:
a first input indicative of geographic information;
a second input indicative of an operating parameter of the machine associated with the geographic information; and
a third input indicative of one or more of a task and a request to monitor data associated with the operating parameter of the machine; and
a controller in communication with the user interface and configured to:
generate a command signal in conjunction with a geo-fence at least partially defined by the geographic information and the operating parameter; and
monitor the operating parameter indicated by the second input and generate an alert via the user interface in conjunction with a geo-fence at least partially defined by the geographic information and the operating parameter.
